(19) United States
(12) Patent Application Publication
(10) Pub. No.: US 2021/0026996 A1
(43) Pub. Date: Jan. 28, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Masamichi KIMURA, Kanagawa (JP)

(73) Assignee: FUJI XEROX CO., LTD., Tokyo (JP)

(21) Appl. No.: 16/737,927

(22) Filed: Jan. 9, 2020

(30) Foreign Application Priority Data
Jul. 25, 2019 (JP) 2019-136804

(51) Int. Cl. G06F 30/10; B33Y 50/00; B29C 64/386

(52) U.S. Cl. CPC G06F 30/10; G06F 2113/10; B29C 64/386; B33Y 50/00

(57) ABSTRACT

An information processing apparatus includes a generation unit that generates three-dimensional model data for modeling a three-dimensional model with an internal structure suitable for a use of a partial shape of the three-dimensional model according to attribute information assigned in correspondence with the partial shape of the three-dimensional model to be modeled based on the three-dimensional model data.

### CROSS-REFERENCE TO RELATED APPLICATIONS

This application is based on and claims priority under 35 USC 119 from Japanese Patent Application No. 2019-136804 filed Jul. 25, 2019.

### BACKGROUND

### (i) Technical Field

The present invention relates to an information processing apparatus and a non-transitory computer readable medium storing a program.

### (ii) Related Art

According to the spread of three-dimensional printers, a three-dimensional modeling object (hereinafter, referred to as “three-dimensional model”) can be modeled from three-dimensional model data. As one typical data format of the three-dimensional model data, a stereolithography (STL) format is used. Data with an STL format is three-dimensional model data in which a three-dimensional shape is represented by a cluster of small triangles (generally referred to as “polygons”), and can define the external shape of the three-dimensional model. However, an internal structure of the three-dimensional model cannot be defined.

As a data format of the three-dimensional model data, a fabricable voxel (FAV) format is used. Data with an FAV format is model data for representing a model by a voxel as a basic element of a three-dimensional object. Unlike the STL format, the FAV format can define the internal structure of the three-dimensional model.

As a method of forming the inside of the three-dimensional model of which the internal structure is not defined, a method of filling the whole inside of the three-dimensional model with a material and a method of filling a portion of the inside of the three-dimensional model with a material are used. The former is generally called “solid model”, and a typical example of the latter method is a sparse structure. The sparse structure is a structure designed by thinning the internal structure of the three-dimensional model in a lattice shape.

FIG. 5A is a perspective view illustrating an example of a three-dimensional model having a three-dimensional shape. FIG. 5A illustrates an example of a three-dimensional model in which a hole shape having a predetermined depth is formed on the upper surface, the hole shape being a partial shape of the three-dimensional model. FIG. 5B is a perspective view illustrating a section when the three-dimensional model illustrated in FIG. 5A that has a solid-type internal structure is cut in a direction of an arrow A. FIG. 5C is a perspective view illustrating a section when the three-dimensional model illustrated in FIG. 5A that has a solid-type internal structure is cut in a direction of an arrow B. FIG. 5D is a perspective view illustrating a section when the three-dimensional model illustrated in FIG. 5A that has a sparse internal structure is cut in a direction of an arrow B.

As illustrated in FIGS. 5B and 5C, in a case of the three-dimensional model with a solid-type internal structure, a strength can be ensured. On the other hand, since the whole inside of the three-dimensional model is filled with a material, an amount of the material is increased, and as a result, a weight of the entire three-dimensional model is increased. In contrast, as illustrated in FIG. 5D, in a case of the three-dimensional model with a sparse internal structure, there are merits that the weight can be reduced while maintaining a strength of a certain level and the amount of the material can be reduced.

Examples of related art include JP2011-043864A and JP2016-182745A.

### SUMMARY

For example, in a case where a hole shape as illustrated in FIGS. 5A to 5D is formed as a partial shape of the three-dimensional model, a use of the hole shape may be a screw hole to which a load is applied, a hole into which a rod is fitted and to which a relatively small load is applied, or the like.

However, in the related art, the internal structure of a periphery of the hole is modeled according to a predetermined method regardless of the use of the hole to be formed.

Aspects of non-limiting embodiments of the present disclosure relate to an information processing apparatus and a non-transitory computer readable medium storing a program that can model a three-dimensional model with an internal structure suitable for a use of a partial shape for each partial shape of the three-dimensional model.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a generation unit that generates three-dimensional model data for modeling a three-dimensional model with an internal structure suitable for a use of a partial shape of the three-dimensional model according to attribute information assigned in correspondence with the partial shape of the three-dimensional model to be modeled based on the three-dimensional model data.

### BRIEF DESCRIPTION OF THE DRAWINGS

Exemplary embodiment(s) of the present invention will be described in detail based on the following figures, wherein:

FIG. 1 is a block diagram illustrating an exemplary embodiment of an information processing apparatus according to the present invention;

FIG. 2A is a perspective view illustrating an example of a three-dimensional model modeled based on three-dimensional model data generated by the information processing apparatus according to the present exemplary embodiment;

FIG. 2B is a perspective view illustrating a section when the three-dimensional model illustrated in FIG. 2A is cut in a direction of an arrow C;

FIG. 2C is a plan view of the three-dimensional model illustrated in FIG. 2B;

FIG. 3A is a perspective view illustrating an example of a three-dimensional model modeled based on three-dimensional model data generated by the information processing apparatus according to the present exemplary embodiment;

FIG. 3B is a perspective view illustrating a section when the three-dimensional model illustrated in FIG. 3A is cut in a direction of an arrow D;

FIG. 4A is a diagram for explaining the presence or absence of a voxel in an FAV format;

FIG. 4B is a diagram for explaining the presence or absence of a voxel in an FAV format;

FIG. 5A is a perspective view illustrating an example of a three-dimensional model;

FIG. 5B is a perspective view illustrating a section when the three-dimensional model illustrated in FIG. 5A that has a solid-type internal structure is cut in a direction of an arrow A;

FIG. 5C is a perspective view illustrating a section when the three-dimensional model illustrated in FIG. 5A that has a solid-type internal structure is cut in a direction of an arrow B; and

FIG. 5D is a perspective view illustrating a section when the three-dimensional model illustrated in FIG. 5A that has a sparse internal structure is cut in a direction of an arrow B.

### DETAILED DESCRIPTION

Hereinafter, an exemplary embodiment of the present invention will be described in detail with reference to the accompanying drawings.

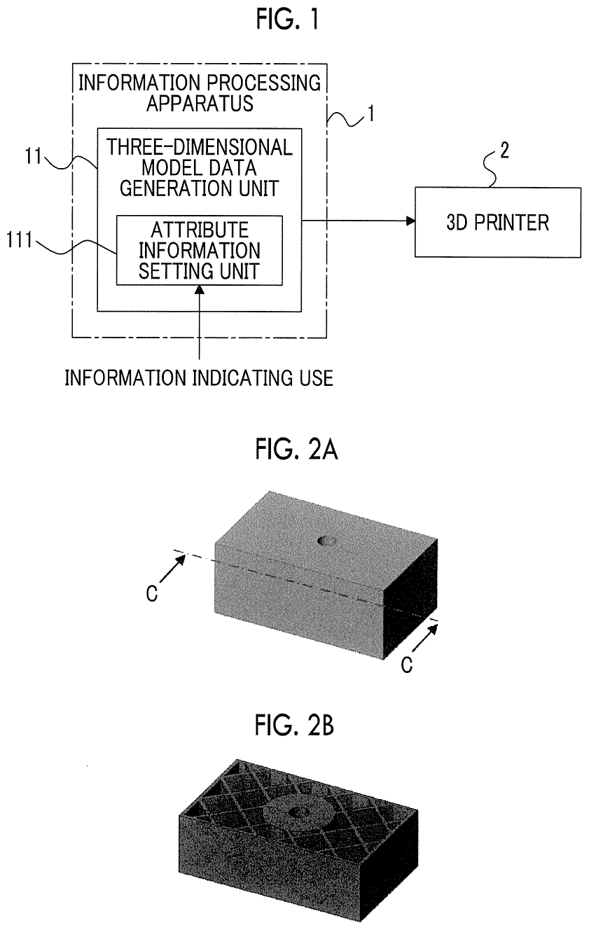

FIG. 1 is a block diagram illustrating an exemplary embodiment of an information processing apparatus 1 according to the present invention. The information processing apparatus 1 according to the present exemplary embodiment can be realized by a general-purpose hardware configuration such as a personal computer (PC) that exists from the past. Accordingly, the information processing apparatus 1 according to the present exemplary embodiment includes a CPU as one form of a processor, a storage unit such as a ROM, a RAM, and a hard disk drive (HDD), a user interface, and a communication unit such as a network interface, as necessary. The user interface may be configured with a mouse and a keyboard as an input unit, and a display as a display unit.

As illustrated in FIG. 1, the information processing apparatus 1 according to the present exemplary embodiment includes a three-dimensional model data generation unit 11. It is noted that components not described in the present exemplary embodiment are omitted from the drawings.

The three-dimensional model data generation unit 11 generates three-dimensional model data for modeling a three-dimensional model according to attribute information, which is assigned in correspondence with a partial shape of the three-dimensional model. Unless otherwise specified, the three-dimensional model data generation unit 11 according to the present exemplary embodiment generates three-dimensional model data according to an FAV data format which can represent data up to the inside of an object (that is, a three-dimensional model). An attribute information setting unit 111 included in the three-dimensional model data generation unit 11 sets attribute information related to a partial shape of a three-dimensional model. The attribute information, which is assigned in correspondence with a partial shape by the attribute information setting unit 111, will be described later.

The three-dimensional model data generation unit 11 in the information processing apparatus 1 is realized by a cooperative operation of a computer with which the information processing apparatus 1 is configured and a program which is operated by a CPU mounted on the computer. Further, the program according to the present exemplary embodiment may be provided by the communication unit, or may be provided by being stored in a computer-readable recording medium such as a CD-ROM or a USB memory. The program provided from the communication unit or the recording medium is installed in the computer, and various types of processing are realized by the CPU of the computer executing the program in order.

Next, before describing an operation according to the present exemplary embodiment, a three-dimensional model, which is modeled by a 3D printer 2 according to three-dimensional model data obtained by an operation of the information processing apparatus 1 according to the present exemplary embodiment, will be described.

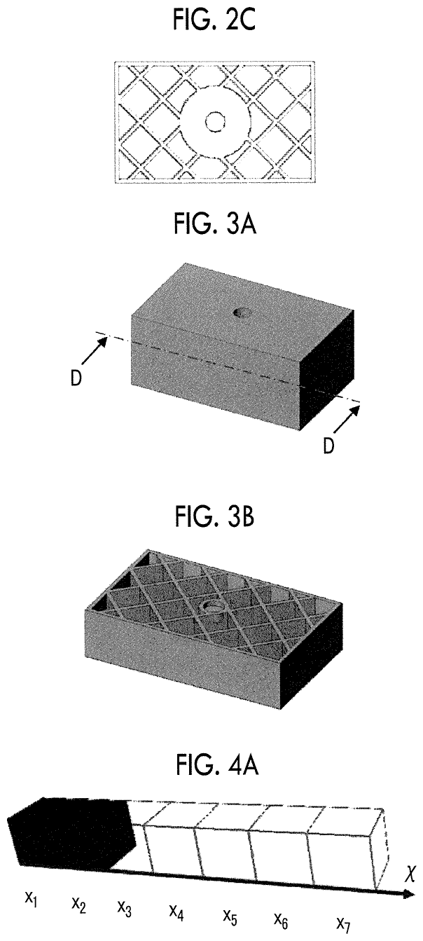

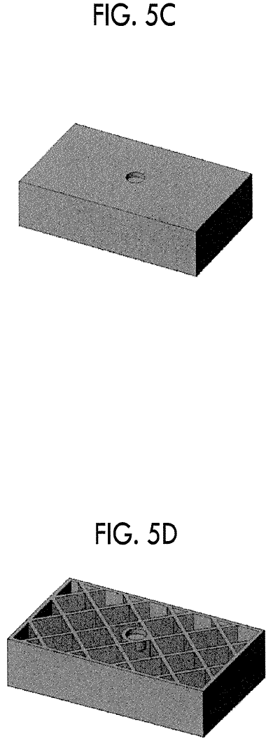

FIG. 2A is a perspective view illustrating an example of a three-dimensional model. FIG. 2A illustrates an example of a three-dimensional model in which a hole shape having a predetermined depth is formed on the upper surface, the hole shape being a partial shape of the three-dimensional model. In the present exemplary embodiment, for easy comparison with an example in related art, the same three-dimensional model as in FIG. 5A is illustrated. FIG. 2B is a perspective view illustrating a section when the three-dimensional model illustrated in FIG. 2A is cut in a direction of an arrow C. FIG. 2B illustrates a perspective view in a case where a use of the hole shape is estimated to be a screw hole from attribute information assigned in correspondence with the hole shape. FIG. 2C is a plan view of the three-dimensional model illustrated in FIG. 2A.

In a case where a use of the hole shape is estimated to be a screw hole, the three-dimensional model data generation unit 11 generates three-dimensional model data for modeling a three-dimensional model with an internal structure suitable for the screw hole. In order to make the hole shape function as a screw hole, a strength of a certain level or higher is required. In a case where it is estimated that a strength of a certain level or higher is required for the use of the hole shape by referring to attribute information assigned in correspondence with the hole shape, as illustrated in FIG. 2B and FIG. 2C, the three-dimensional model data generation unit 11 generates three-dimensional model data for modeling a three-dimensional model with an internal structure in which a periphery of the hole shape is thick. Further, the three-dimensional model data generation unit 11 determines a thickness of the periphery of the hole shape according to setting contents of the attribute information. The attribute information will be described later.

In attribute information of a partial shape of the three-dimensional model illustrated in FIG. 2A, a use of a partial shape other than a screw hole shape is not set, or a use of a partial shape such as a hole shape requiring a strength of a certain level or higher is not set. Therefore, the three-dimensional model data generation unit 11 generates three-dimensional model data for modeling a three-dimensional model with an internal structure having the same strength as a strength of a solid model by making the periphery of the hole shape thick. In addition, by modeling the other portions with a sparse structure, a weight of the entire three-dimensional model can be reduced while a strength of the entire three-dimensional model can be maintained to a certain strength. Further, an amount of a material of the three-dimensional model can be reduced.

FIG. 3A is a perspective view illustrating an example of a three-dimensional model, which has the same shape as the shape of the three-dimensional model illustrated in FIG. 2A. FIG. 3B is a perspective view illustrating a section when the three-dimensional model illustrated in FIG. 3A is cut in a direction of an arrow D. FIG. 3B illustrates a perspective view in a case where a use of the hole shape is estimated to be a hole for fitting a rod from attribute information assigned in correspondence with the hole shape.

In a case where a use of the hole shape is estimated to be a hole for fitting a rod (hereinafter, referred to as a “fitting hole”), the three-dimensional model data generation unit 11 generates three-dimensional model data for modeling a three-dimensional model with an internal structure suitable for the fitting hole. In order to make the hole shape function as a fitting hole, unlike the case of the screw hole, the three-dimensional model may have a normal strength. In a case where it is estimated that a normal strength is required for the use of the hole shape by referring to attribute information assigned in correspondence with the hole shape, as illustrated in FIG. 3B, the three-dimensional model data generation unit 11 generates three-dimensional model data for modeling a three-dimensional model with a normal internal structure, that is, a sparse structure, in which the periphery of the hole shape is different from the periphery of the screw hole. In the present exemplary embodiment, the three-dimensional model has a strength lower than the strength of a solid model. On the other hand, the three-dimensional model has a sparse structure as a normal internal structure. Thus, the strength of the three-dimensional model can be maintained to a certain strength, and a weight of the three-dimensional model can be reduced. Further, an amount of a material of the three-dimensional model can be reduced.

In the above description, the hole shape is described as an example of a partial shape. For example, as illustrated in FIG. 2A, in a case where the three-dimensional model has a corner, or in a case where the three-dimensional model corresponds to a component of a finished product and abuts against an article such as a main body of the finished product or another component at a position at which a partial shape of the component is formed, it is preferable to model the three-dimensional model by increasing a strength at the position of the partial shape. In this case, the three-dimensional model data generation unit 11 generates three-dimensional model data for modeling a three-dimensional model with an internal structure according to the position of the partial shape of the three-dimensional model. Specifically, by forming an internal structure such that a strength in the vicinity of a corner of a three-dimensional model is stronger than strengths of the other portions, the three-dimensional model data generation unit 11 generates three-dimensional model data for modeling a three-dimensional model having a strength that is not easily damaged even in a case where the three-dimensional model is dropped, for example. In addition, by forming the internal structure such that the strength at a position at which the partial shape is formed is stronger than strengths of the other portions, the partial shape being abutted against another article, the three-dimensional model data generation unit 11 generates three-dimensional model data for modeling a three-dimensional model having a strength that is not easily damaged by engagement with another article.

Next, the attribute information assigned in correspondence with the partial shape according to the present exemplary embodiment will be described. Here, a hole shape is described as an example of a partial shape. In the following description, it is assumed that a data format of the three-dimensional model is an FAV format which can define an internal structure by using a voxel.

The FAV format includes four main parts of <metadata>, <palette>, <voxel>, and <object>. For each layer on an XY plane of a three-dimensional grid defined by <grid> included in <object>, attribute information indicating the presence or absence of a voxel at each grid position in the layer is defined.

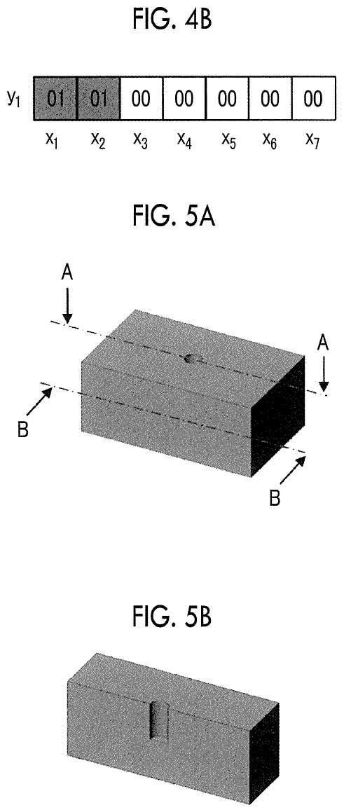

FIGS. 4A and 4B illustrate the presence or absence of a voxel at each position of one column on the XY plane defined by <grid>. In FIG. 4A, positions at which a voxel is present (that is, positions of x₁ and x₂) are illustrated by being colored, and in FIG. 4B, “01” indicating the presence of a voxel is set as an attribute value. In the FAV format, an attribute value “00” can be set to grid positions x₃ to x₇ at which a voxel is not present, as attribute information. Therefore, in the present exemplary embodiment, similar to the attribute information indicating that there is no voxel, attribute information related to a hole shape is set to the grid positions x₃ to x₇, the attribute information indicating that a hole shape corresponds to a screw hole or a fitting hole.

Further, as the attribute information, not only information directly representing a use such as a screw hole or a fitting hole, but also data specifying a specification corresponding to a use of a partial shape may be set. For example, when modeling a three-dimensional model, at least one of a strength, a weight, or a material required for the partial shape may be set. For example, in a case where the hole shape corresponds to a screw hole, in order to make the hole shape function as a screw hole, data such as a strength that is required for the screw hole is set as attribute information of the hole shape. The data is an example, and is not limited thereto. The three-dimensional model data generation unit 11 estimates that a use of the hole shape of the three-dimensional model is a screw hole by referring to the data specifying a specification, and generates three-dimensional model data such that the periphery of the hole shape is thick as described above. Further, the three-dimensional model data generation unit 11 determines a thickness of the hole shape according to a value of the data specifying a specification, for example, a strength required for the screw hole, a material of the screw hole, or the like, the strength being indicated by a fastening torque.

Further, the attribute information assigned in correspondence with the partial shape of the three-dimensional model may not be set to the partial shape itself, that is, the grid positions x₃ to x₇ in the above example. For example, attribute information related to a hole shape may be set to <user_defined_map> of <structure> included in <object>.

The attribute information indicating the presence or absence of a voxel of the hole shape may not be used as attribute information of the hole shape. For example, in a model A′ which is obtained by performing a Boolean operation of “a solid model A before a Boolean operation” and “a solid model B with a screw hole shape” (A not B), information indicating a use of “screw hole” may be held as attribute information for a voxel of an intersection portion (A and B) of the model A and the model B. In the case of the FAV format, the attribute information is held as <user_defined_map>.

Alternately, the attribute information may be set to a voxel of the hole shape. According to FIG. 4, a surface as a boundary of the hole is formed by the voxel at the grid position x₂. Thus, attribute information related to the hole shape may be assigned to the voxel at the grid position x₂ forming the surface. In the present exemplary embodiment, since the FAV format is used as an example, attribute information related to the hole shape can be set to the voxels at the grid positions x₃ to x₇. Thereby, the internal structure of the three-dimensional model can be defined. On the other hand, in a case of three-dimensional model data with an STL format that can define only a surface shape of a three-dimensional model by a polygon, a grid, and the like (hereinafter, collectively referred to as “polygon”), since the hole shape has no substance, attribute information indicating a use cannot be assigned to the hole shape. In this case, as attribute information of the polygon of the hole shape of the three-dimensional model, attribute information related to the hole shape may be set.

The attribute information related to the hole shape is not necessarily assigned to the hole shape itself as described above. For example, the attribute information may be assigned to a surface or <user_defined_map>. For this reason, in the present exemplary embodiment, the attribute information related to the hole shape is described as “attribute information assigned in correspondence with the hole shape”. Thus, a target to which the attribute information is assigned is not limited to the hole shape itself.

Next, an operation according to the present exemplary embodiment will be described. The attribute information setting unit 111 receives attribute information which is set by a user. The attribute information received by the attribute information setting unit 111 is attribute information for the three-dimensional model data to be processed, and is information indicating a use of a component shape. The attribute information setting unit 111 assigns the received attribute information to the grid positions x₃ to x₇ at which a voxel is not present, <user_defined_map>, or a surface. A target to which the attribute information is assigned is appropriately determined according to a partial shape of a three-dimensional model or according to a data format of a three-dimensional model. For example, in a case where the partial shape corresponds to an actual corner or the like, the attribute information may be assigned to a target such as a corner.

In a case of generating three-dimensional model data with an FAV format by converting three-dimensional model data with an STL format, the attribute information setting unit 111 may set attribute information by converting information related to the partial shape, that is, information indicating a use of the partial shape, from an STL format into an FAV format, without receiving attribute information from the user. The three-dimensional model data generation unit 11 generates three-dimensional model data for modeling a three-dimensional model with an internal structure suitable for the partial shape by referring to the assigned attribute information related to the partial shape.

In the above description, the hole shape is taken as an example of the partial shape of the three-dimensional model, and the description has been made focusing on the hole shape. That is, the hole shape is formed so as to have a thickness (that is, only the portion is formed in a solid model form) by referring to the attribute information indicating a use, and the other portions are formed so as to have a sparse structure with a predetermined setting since the attribute information indicating a use is not set to the other portions. Here, the attribute information indicating a use may be set to all the grid positions.

In the present exemplary embodiment, the internal structure is formed in a solid model form in order to increase a strength. On the other hand, the internal structure is not necessarily formed in a solid model form as long as a required strength can be obtained. For example, the internal structure may be formed with a sparse structure having finer grids than usual grids.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a generation unit that generates three-dimensional model data for modeling a three-dimensional model with an internal structure suitable for a use of a partial shape of the three-dimensional model according to attribute information assigned in correspondence with the partial shape of the three-dimensional model to be modeled based on the three-dimensional model data.

2. The information processing apparatus according to claim 1,
wherein the attribute information is information indicating the use of the partial shape of the three-dimensional model.

3. The information processing apparatus according to claim 1,
wherein the attribute information is data specifying a specification according to the use of the partial shape of the three-dimensional model.

4. The information processing apparatus according to claim 2,
wherein the attribute information is data specifying a specification according to the use of the partial shape of the three-dimensional model.

5. The information processing apparatus according to claim 3,
wherein the data specifying the specification is at least one of a strength, a weight, or a material required for the partial shape when the three-dimensional model is modeled.

6. The information processing apparatus according to claim 4,
wherein the data specifying the specification is at least one of a strength, a weight, or a material required for the partial shape when the three-dimensional model is modeled.

7. The information processing apparatus according to claim 5,
wherein, in a case where the partial shape of the three-dimensional model is a hole shape and it is estimated that a strength of a certain level or higher is required for the use of the hole shape from the attribute information assigned in correspondence with the hole shape, the generation unit generates the three-dimensional model data for modeling the three-dimensional model having an internal structure in which a periphery of the hole shape is thick.

8. The information processing apparatus according to claim 6,
wherein, in a case where the partial shape of the three-dimensional model is a hole shape and it is estimated that a strength of a certain level or higher is required for the use of the hole shape from the attribute information assigned in correspondence with the hole shape, the generation unit generates the three-dimensional model data for modeling the three-dimensional model having an internal structure in which a periphery of the hole shape is thick.

9. The information processing apparatus according to claim 7,
wherein the generation unit determines a thickness of the periphery of the hole shape according to the data specifying the specification.

10. The information processing apparatus according to claim 8,
wherein the generation unit determines a thickness of the periphery of the hole shape according to the data specifying the specification.

11. The information processing apparatus according to claim 1,
wherein the generation unit generates the three-dimensional model data for modeling the three-dimensional model with an internal structure according to a position of the partial shape of the three-dimensional model.

12. The information processing apparatus according to claim 11,
wherein, in a case where the three-dimensional model abuts against another article at a position at which the partial shape is formed, the generation unit generates the three-dimensional model data for modeling the three-dimensional model with an internal structure in which a strength of the partial shape is higher than a strength of a portion which does not abut against another article.

13. The information processing apparatus according to claim 1, further comprising:
a determination unit that determines a target to which the attribute information is assigned according to the partial shape of the three-dimensional model.

14. The information processing apparatus according to claim 13,
wherein the determination unit assigns the attribute information as attribute information of the partial shape of the three-dimensional model.

15. The information processing apparatus according to claim 14,
wherein the partial shape of the three-dimensional model is a hole shape.

16. A non-transitory computer readable medium storing a program for causing a computer to function as:
a generation unit that generates three-dimensional model data for modeling a three-dimensional model with an internal structure suitable for a use of a partial shape of the three-dimensional model according to attribute information assigned in correspondence with the partial shape of the three-dimensional model to be modeled based on the three-dimensional model data.

17. An information processing apparatus comprising:
generation means for generating three-dimensional model data for modeling a three-dimensional model with an internal structure suitable for a use of a partial shape of the three-dimensional model according to attribute information assigned in correspondence with the partial shape of the three-dimensional model to be modeled based on the three-dimensional model data.
